(19) United States
(12) Patent Application Publication
(10) Pub. No.: US 2006/0254867 A1
(43) Pub. Date: Nov. 16, 2006

(54) Wheel supporter with a brake

(76) Inventor: Li-Lan Yan, Puzih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/127,121

(22) Filed: May 12, 2005

(51) Int. Cl. F16D 55/04; F16D 65/00

(52) U.S. Cl. 188/73.1

(57) ABSTRACT

A wheel supporter with a brake includes a rotary shaft, a base, a pedal, a brake plate and a return spring. The base has a covering member, a shaft support member, and an eccentric support member. The eccentric support member has an upper stage provided with a sidewise round post, and the brake plate has a front projection, two wings provided in a rear portion, and an upper recess formed to mount on the round post. If the pedal is stepped down, the brake plate is pressed down to force the wings contact the wheel to produce frictional resistance against the wheel, and at the same time the front projection of the brake plate fits in one of the gaps formed by every two teeth of a disc gear fixed with a lower end of the rotary shaft to stop the rotary shaft immovable. The brake plate is easily combined with the wheel supporter, and applicable to various types of wheels.

### BACKGROUND OF THE INVENTION

1. Field of the Invention

This invention relates to a wheel supporter with a brake, particularly to one provided with a pedal stepped to let a brake plate to swing like a seesaw and possible to stop a wheel and the wheel supporter at the same time, and the brake plate formed integral possible to be combined with the wheel supporter quickly, and applicable to various types of wheel supporters.

2. Description of the Prior Art

A wheel supporter used for a small diameter wheel are often combined with a brake for braking and stopping the wheel, especially a rotary wheel is structured to rotate and turn around, and the brake stops the wheel both from rotating and from turning around at the same time or separately. Further, a U.S. Pat. No. 4,941,552, “Castor with brake mechanism” applied on Oct. 7, 1988, discloses a wheel supporter for a motorcycle, which has a brake fixed to mount on the wheel supporter, which cannot be combined quickly, needing to take off other components. So this castor with a brake mechanism may cost high, involving many processes in assembling.

### SUMMARY OF THE INVENTION

One purpose of the invention is to offer a wheel supporter with a brake quickly combined with the wheel supporter, simplifying assembling processes, reducing its cost, and applicable to various types of wheel supporters for small wheels.

Another purpose of the invention is to offer a wheel supporter with a brake simple in operating for a user to easily stop the wheel from rotating or turning around.

The wheel supporter with a brake in the invention includes a rotary shaft, a base, a pedal, a brake plate, and a return spring.

The rotary shaft has a disc gear fixed with its lower end.

The base is composed of a covering member, a shaft support member and an eccentric support member. The covering member has its upper portion pivotally connected with the rotary shaft, and its rear portion provided with a long hole. The upper end of the eccentric support member is connected with the covering member at a lower point away from the axial line and the lower end is connected with the shaft support member. The eccentric support member has its upper stage provided with a round post extending sidewise and its lower stage provide with a rib at a proper location.

The pedal has a lateral hole for a shaft to fit in for connecting pivotally in the long hole of the covering member.

The brake plate is curved, having a front projection and an upper recess formed in an intermediate portion and mounted on the post of said eccentric support member so that the brake plate may seesaw up and down with the post as a pivot, and a wing extending down from a rear portion.

The return spring has its one end resting on a lower surface of the brake plate, and other end contacting the rib of the eccentric support member. And at least a wheel is pivotally connected with the shaft support member:

When the pedal is stepped down, the brake plate is moved down to let the wing of the brake plate contact the wheel to produce frictional resistance to the rotating wheel, and the front projection of the brake plate fits in one of gaps formed by every two teeth of a disc gear fixed at the lower end of the rotary shaft to stop the base from turning around.

### BRIEF DESCRIPTION OF DRAWINGS

This invention will be better understood by referring to the accompanying drawings, wherein;

FIG. 1 is an exploded perspective view of a preferred embodiment of a wheel supporter with a brake in the present invention;

FIG. 2 is a rear cross-sectional view of the preferred embodiment of a wheel supporter with a brake in the present invention;

FIG. 3 is a side cross-sectional view of a wheel supporter under a freed condition with a pedal not stepped down in the present invention; and,

FIG. 4 is a side cross-sectional view of the wheel supporter under a fixed condition with the pedal stepped down in the present invention.

### DETAILED DESCRIPTION OF THE PREFERRED EMBODIMENT

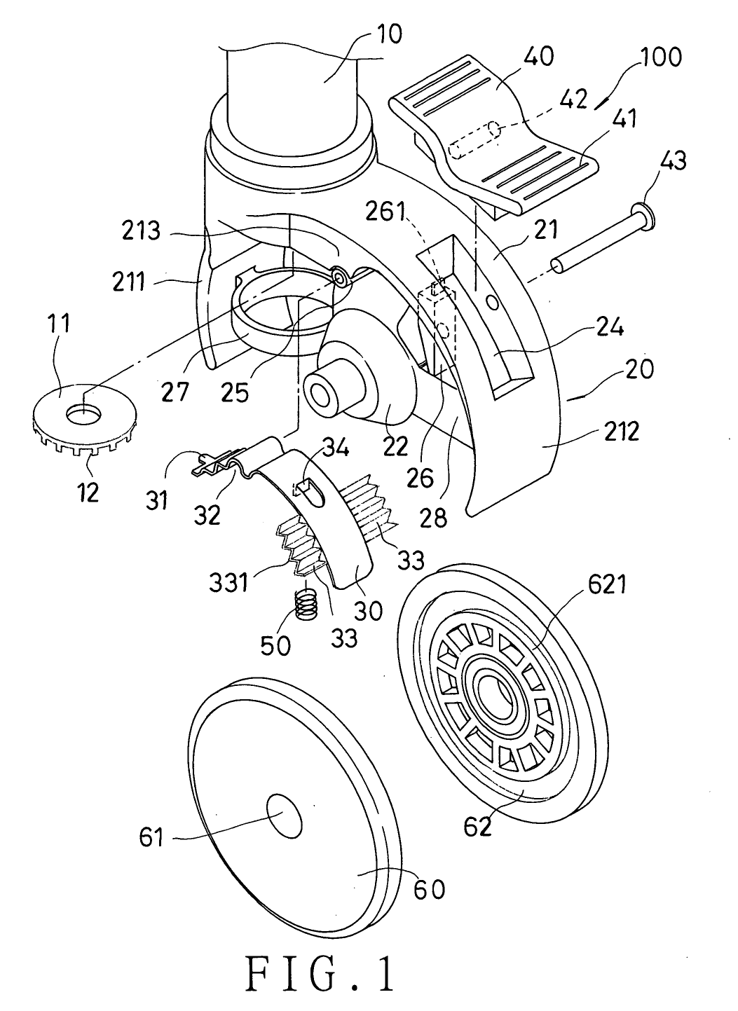

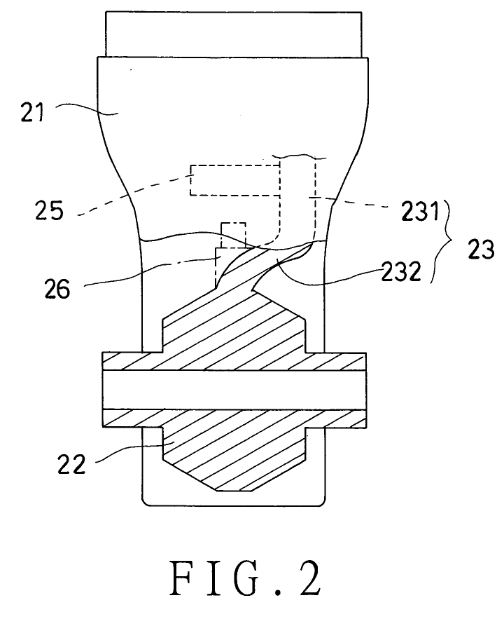

A preferred embodiment of a wheel supporter with a brake in the present invention, as shown in FIGS. 1 to 4, includes a rotary shaft 10, a base 20, a brake plate 30, a pedal 40, and a return spring 50.

The rotary shaft 10 is composed of a shaft body extending from a vehicle, and a disc gear 11 fixed around the lower end of the shaft body and having a plurality of teeth 12 spaced apart equidistantly to form a plurality of gaps and extending downward from its outer circumference. But the teeth 12 can be arranged in other ways.

The base 20 is connected with the rotary shaft 10 functioning as a pivot, composed of a covering member 21, a shaft support member 22, and an eccentric supporting member 23 located between the covering member 21 and the shaft supporting member 22. The covering member 21 has its upper portion pivotally connected with the rotary wheel 10, and a long hole 24 formed in a rear portion. The eccentric support member 23 consists of an upper stage 231 and a lower stage 232, with the upper stage 231 being vertical and the lower stage 232 bending down slantingly from the upper stage 231 to the left side. Further, the upper end of the eccentric support member 23 connects with a proper location on a lower portion of the covering member 21 away from the axial line of the rotary shaft, such as on the left or the right side of the intermediate portion of the covering member 21, and the lower end aligned to the axial line and connected with the shaft support member 22. The upper stage 231 has a round post 25 extending laterally, and the lower stage 232 has a rib 26 at a proper location.

The base 20 further has a front upholding member 27 and a rear upholding member 28, and the front upholding member 27 is annular, having a front end connected to a front vertical wall 211 of the covering member 21 and a rear end connected to the shaft support member 22, functioning to reinforce supporting and buffering. The rear upholding member 28 has a rear end connected to the rear portion of the covering member 21, and a front end connected to the shaft support member 22.

The brake plate 30 is curved and combined with the round post 25 of the eccentric support member 23, having a front projection 31, an upper curved recess 32 mounted on the round post 25 so that the brake plate may seesaw up and down with the round post 25 as a fulcrum. Further, a position block 213 is provided between the covering member 21 and the round post 25 for limiting the seesawing distance of the brake plate 30.

The brake plate 30 further has at least a zigzag wing 33 extending down from the rear portion, and in this embodiment two zigzag wings 33 are formed at the right and left side of the brake plate 30. The zigzag wing 33 is curved, supplying geometrical resistance such as tips of the zigzag wing 33 or having a rough lower surface, and made of material with substantial frictional force. Further, a downward small piece 34 is formed by pressing.

Next, the pedal 40 is pivotally fitted in the long hole 24 of the covering member 21 for stepping down, having an upper anti-slip stepping surface 41, a sidewise hole 42 in the lower portion for a shaft 43 to fit through and for movably fixing the pedal 40 with the covering member 21.

After the brake plate 30 is mounted on the round post 25, the return spring 50 is placed between the brake plate 30 and the shaft support member 22 for elastically pushing up the brake plate 30 after pressed down. The return spring 50 has an upper end resting on a lower surface of the brake plate 30 and kept stable by the downward small piece 34 and a lower end contacting the rib 26 of the eccentric support member 23 and kept stable by a projection 261 of the rib 26.

The wheels 60 are pivotally supported respectively at the right and the left side of the shaft support member 22 of the base 20, having a center shaft hole 61 and an annular groove 62 in the intermediate annular portion of one side surface between the shaft hole and the outer circumference. Then the zigzag wing 33 fits in the annular groove 62 so that the brake plate 30 may contact with an inner wall 621 of the annular groove 62 and produce frictional resistance for stopping or braking the wheel 60.

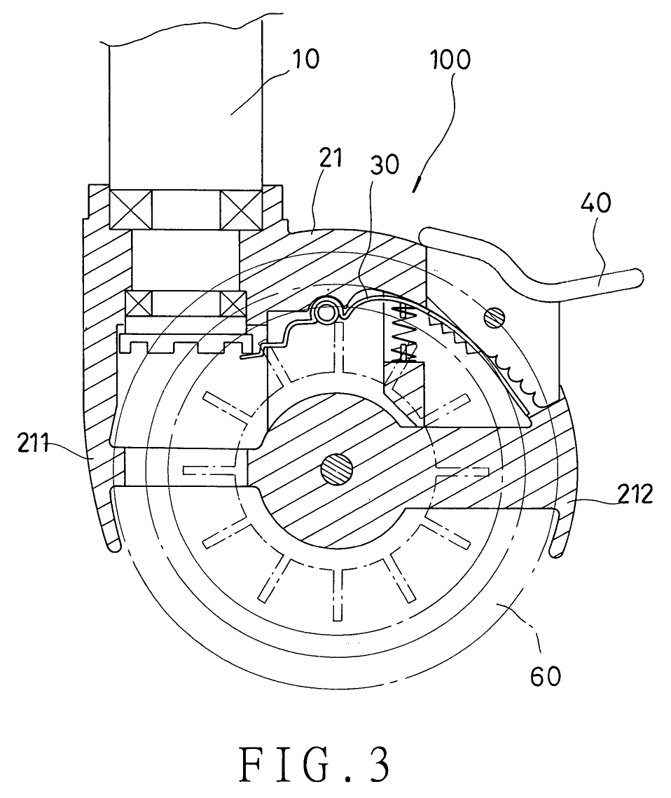

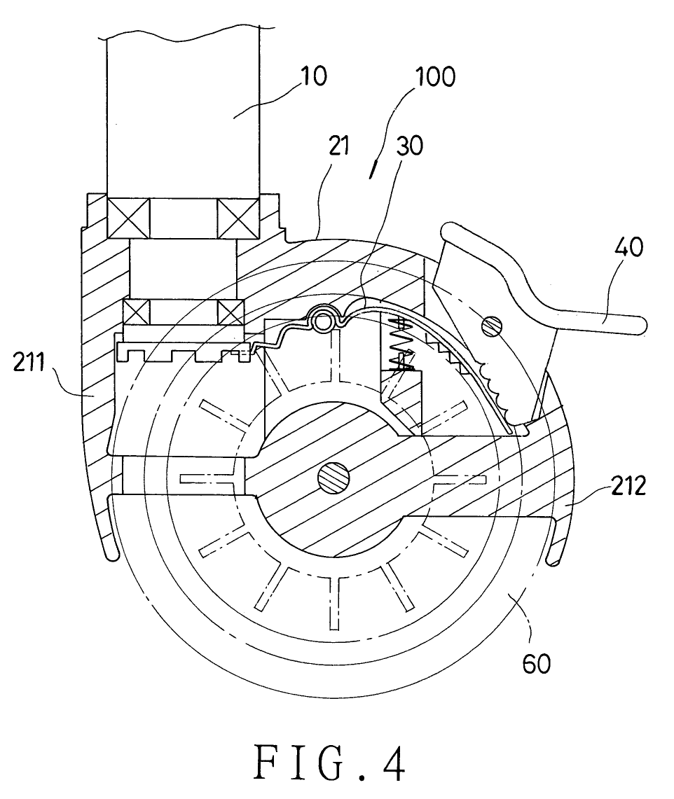

In using, referring to FIGS. 3 and 4, the rotary shaft 10 pivotally connected to the base 20 can permit the wheel 60 to turn around, and the wheel 60 can rotate by means of the pivotal connection of the wheel 60 with the shaft support member 22. Therefore, the wheel 60 needs less force in turning and rotating. If the wheel 60 is to be stopped, only step down the pedal 40, then the rear portion of the brake plate 30 is pressed down against the return spring 50, with the zigzag wings 33 contacting the wheel 60 and producing frictional resistance against the rotating wheel 60, which is then stopped immovable. In addition, with the round post 25 functioning as a pivot, the front projection 31 of the brake plate 30 may fit in one of the gaps between the teeth 12 of the disc gear 11, so the base 20 is also stopped immovable, as the wheel 60 is stopped at the same time.

On the contrary, if the stopping condition of the wheel 60 and the base 20 is to be freed, only release the pedal 40 to move back to the original position, letting the return spring 50 regaining its elasticity to push the brake plate 30 to its upper original position. Then the brake plate 30 can be separated from both the wheel 60 and the disc gear 11, freeing the wheel 60 and the base 20.

The invention has the following advantages, as can be seen from the foresaid description.

1. The provision of the eccentric support member can allow the brake plate directly connected to the round post, easily and quickly let the brake plate and the base assembled together, without needing complicated components, improving the conventional structure.

2. Only pressing down the pedal can keep the wheel and the shaft support member immovable, and no complicated operation is required for braking or stopping the wheel and wheel supporter either on a flat ground or on a slope.

3. Its structure is simple for easy manufacture and suitable for mass production.

While the preferred embodiment of the invention has been described above, it will be recognized and understood that various modifications may be made therein and the appended claims are intended to cover all such modifications that may fall within the spirit and scope of the invention.

What is claimed is:

1. A wheel supporter with a brake comprising:
A rotary shaft for combining with said wheel supporter, a disc gear fixed at a lower end of said rotary shaft;
A base consisting of a covering member, a shaft support member and an eccentric support member, said covering member having its upper portion pivotally connected to said rotary shaft, said eccentric support member having its upper end connected to said covering member at a lower point away from the axial line of said rotary shaft and its lower end connected to said shaft support member, said eccentric support member having an upper stage provided with a round post extending sidewise and a lower stage provided with a projecting rib at a proper location;
A pedal combined with said covering member with a shaft;
A brake plate being curved and having a front projection and an upper recess in an intermediate portion, said upper recess mounted on said round post of said eccentric support member to let said brake plate swing up and down like a seesaw with said round post serving as a fulcrum, said brake plate having a rear portion provided with at least a zigzag wing extending under;
A return spring having an upper end resting against a lower surface of said brake plate and a lower end contacting said rib of said eccentric support member;
At least a wheel pivotally connected with said shaft support member; and,
Said brake plate having its rear portion pressed down by said pedal if said pedal is stepped down so that said wing of said brake plate may contact forcefully said wheel to produce frictional resistance against said wheel being rotating, said front projection of said brake plate fitting in one of the gaps formed by every two teeth of said disc gear so that said base and said wheel may be stopped immovable.

2. The wheel supporter with a brake as claimed in claim 1, wherein said disc gear has a plurality of teeth spaced apart equidistantly and extending down from its outer circumference.

3. The wheel supporter with a brake as claimed in claim 1, wherein said base has a front upholding member and a rear upholding member, said front upholding member is annular, having a front end connected to said front vertical wall of said covering member and a rear end connected to said shaft support member, and said rear upholding member has its one end connected to said rear portion of said covering member and the other end connected to said shaft support member.

4. The wheel supporter with a brake as claimed in claim 1, wherein a position block is placed between said round post and said covering member for limiting the swinging distance of said brake plate.

5. The wheel supporter with a brake as claimed in claim 1, wherein said wing of said brake plate is corrugated with sharp tips for increasing frictional force.

6. The wheel supporter with a brake as claimed in claim 1, wherein said wheel has an annular groove in a side surface between said shaft hole and its outer circumference, said wing of said brake plate fits in said annular groove, and said wing contacts with an inner side wall of said annular groove when said brake plate is pressed down by said pedal, producing frictional force to stop said wheel immovable.

7. The wheel supporter with a brake as claimed in claim 1, wherein two wheels are provided pivotally connected respectively at the right and left sides of said shaft support member, and two wings are provided with said brake plate.

8. The wheel supporter with a brake as claimed in claim 1, wherein said covering member further has a long hole formed on the rear portion for said pedal to fit therein and be pivotally connected thereto.
